(19) United States
(12) Patent Application Publication
(10) Pub. No.: US 2007/0138217 A1
(43) Pub. Date: Jun. 21, 2007

(54) Cup carrier

(76) Inventor: Barbara Hranilovich, Lansing, MI (US)

Correspondence Address: DEVINE, MILLIMET & BRANCH, P.A., 111 AMHERST STREET, BOX 719, MANCHESTER, NH, 03105, US

(21) Appl. No.: 11/640,023

(22) Filed: Dec. 15, 2006

Related U.S. Application Data
(60) Provisional application No. 60/750,321, filed on Dec. 15, 2005.

(51) Int. Cl. A45C 13/40; A45F 5/00; B42F 13/00; B65D 25/00

(52) U.S. Cl. 224/148.6; 220/737; 224/268; 190/102; 248/339

(57) ABSTRACT

A cup carrier for receiving a cup has a sleeve for retaining a cup. The sleeve defines an opening to receive the cup. The sleeve has a plurality of attachment points. The cup carrier has a pair of strings. Each of the strings is attached at a pair of points to the sleeve at the attachment points forming a loop in each of the strings. The strings can be retained to hold the cup in generally a vertical position allowing the user to place the cup without the need to locate a flat location. In addition, the user can tote the cup in the cup carrier while using the hand concurrently to hold or tote other items.

### CROSS-REFERENCE TO RELATED APPLICATIONS

The present application claims the benefit of Provisional Patent Application No. 60/750,321 filed Dec. 15, 2005, which is incorporated herein by reference.

### BACKGROUND INFORMATION

Cup carriers are used to group individual cups into a single portable package. Cup carriers enable a user to carry several cups with a single hand. Cup carriers are generally either flexible ring carriers or single-piece paperboard box carriers. Flexible ring carriers are generally constructed of a thin lightweight sheet of thermoplastic material and are usually designed to carry between one and four cups.

Cup holders are designed for the purpose of providing insulation so that the user's hand is spaced from the cup. Cup holders are made with corrugated paper or embossed pattern.

### SUMMARY

It has been recognized that both cup carriers and cup holders have the short coming of requiring a flat surface on which to place the cup. In addition, the cup carrier with multiple cups does not facilitate drinking from the cup with the cup in the cup carrier.

In one arrangement of a cup carrier for receiving a cup according to the invention, the cup carrier has a sleeve for retaining a cup. The sleeve defines an opening to receive the cup. The sleeve has a plurality of attachment points. The cup carrier is a pair of strings. Each of the strings is attached at a pair of points to the sleeve at the attachment points forming a loop in each of the strings. The strings can be retained to hold the cup in generally a vertical position allowing the user, without the need to locate a flat location, to hold the cup. In addition, the user can tote the cup in the cup carrier while using the hand concurrently to hold or tote other items. Accordingly, the conventional approach of requiring a generally flat surface on which to place the cup when the user is not retaining the cup carrier is unnecessary.

In one arrangement, a cup carrier for receiving a cup has a sleeve defining an opening to receive the cup. The sleeve has a plurality of attachment points. The cup carrier also has a pair of strings. Each of the strings is attached at a pair of points to the sleeve at the attachment points forming a loop in each of the strings.

In one arrangement, the plurality of attachments points are four points equally spaced around the circumference of the sleeve. The sleeve forms a frusto-conical opening for receiving the cup. In one arrangement, each of the strings has a length of greater than 10 inches between attachment points to the sleeve.

In one arrangement, the sleeve is an elongated band having a first edge and second edge, the first edge overlapping the second edge to form the sleeve. The first edge of the elongated band is secured to the second edge of the elongated band by at least one fastener. In another arrangement, the first edge of the elongated band is secured to the second edge of the elongated band by an adhesive.

In an arrangement, the sleeve has a minimum of two fold lines allowing the sleeve to fold to generally a flat shape for storage.

In another arrangement, the sleeve forms a cylindrical opening for receiving the cup which is a cylindrical can. The cup carrier is a retaining band for facilitating retaining the cup.

In one method, the cup carrier includes a sleeve having an upper edge and a lower edge, the sleeve forming an opening for receiving the cup. The sleeve has a plurality of attachment points and a pair of strings attached to the sleeve. A cup is placed into the opening defined by the sleeve. The strings are retained to hold the cup.

In an arrangement, the strings are retained by a hook. In one arrangement, the hook is located in a lavatory of the group consisting of an outhouse, portable toilet, bathroom, stall, and latrine. In one arrangement, the hook is located on luggage. In an arrangement, the strings are retained by a hand.

In one arrangement of a cup carrier for receiving a cup, the cup carrier has an elongated band having a sector of annulus shape with an upper edge, a lower edge, a first edge and a second edge. The first edge underlies and is secured to the second edge to form a sleeve defining a frusto-conical opening for receiving the cup. The sleeve has four attachment points equally spaced around the circumference of the sleeve. The cup carrier has a pair of strings. Each of the strings is attached at a pair of points to the sleeve at the attachment points forming a loop in each of the strings.

In an arrangement, each of the strings has a length of between 14 and 20 inches between attachment points to the sleeve. The elongated band has a height of between of 2½ and 2¾ inches. The four attachment points are located in the second fifth from the upper edge of the elongated band. The elongated band is formed of a vinyl material.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a front view of a cup carrier with a cup shown in phantom;

FIG. 2 is an exploded view of an alternative arrangement of the cup carrier;

FIG. 3 is a perspective view of the cup carrier attached to a hook;

FIG. 4 is a view of the cup carrier hanging from a finger;

FIG. 5 is a side view of a user pulling a luggage holder and holding the cup carrier;

FIG. 6 is a front view of an alterative arrangement of the cup carrier; and

FIG. 7 is a side view of a cup carrier being held by the middle finger.

### DETAILED DESCRIPTION OF THE PREFERRED EMBODIMENTS

A cup carrier for receiving a cup has a sleeve for retaining a cup. The sleeve defines an opening to receive the cup. The sleeve has a plurality of attachment points. A pair of strings where each of the strings is attached at a pair of points to the sleeve at the attachment points forming a loop in each of the strings. The strings can be retained to hold the cup in generally a vertical position allowing the user without the need to locate a flat location to place the cup. In addition, the user can tote the cup in the cup carrier while using the hand concurrently to hold or tote other items. The user can drink form the cup with the cup in the cup carrier. Accordingly, the conventional approach of requiring a generally flat surface on which to place the cup when the user is not retaining the cup carrier is unnecessary.

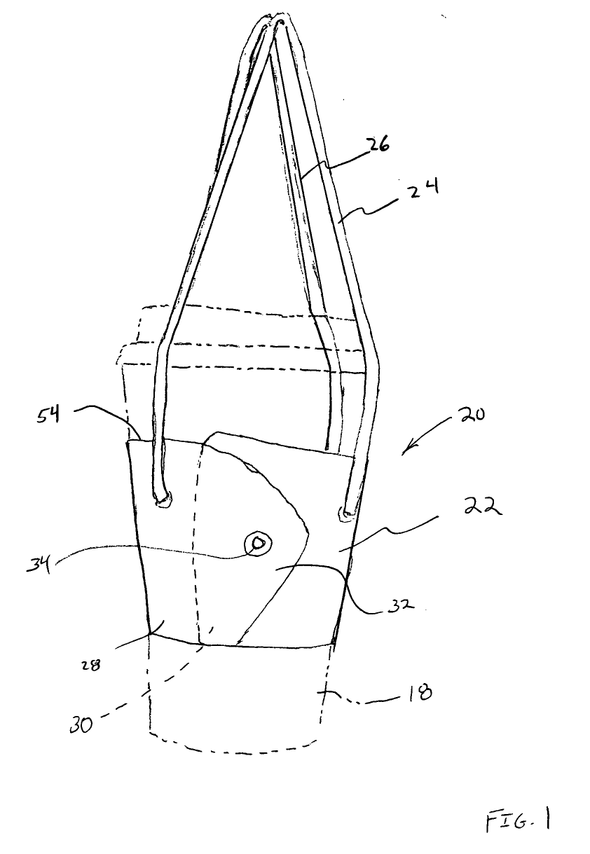

Referring to FIG. 1, a cup carrier 20 with a cup 18 in phantom is shown. The cup carrier 20 has a sleeve 22 and a pair of strings 24 and 26. The strings 24 and 26 are each attached to the sleeve 22 in proximity to the ends of the strings 24 and 26. The sleeve 22 is an elongated band 28 having a first edge 30, shown in hidden line, underlying a second edge 32. The edges 30 and 32 are secured together with a fastener 34.

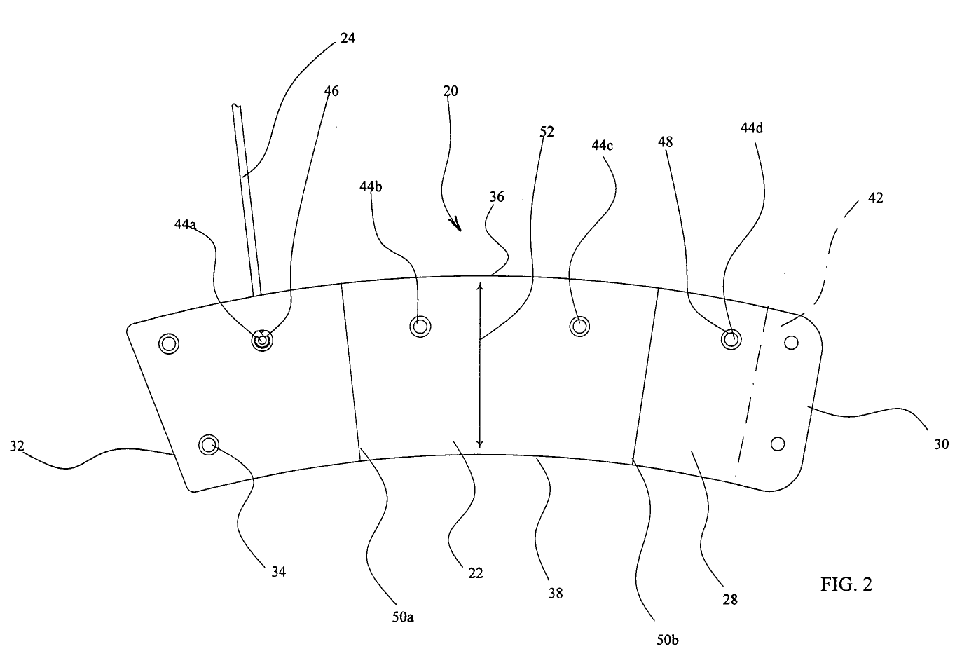

Referring to FIG. 2, an exploded view of an alternative cup carrier 20 is shown. The sleeve 22 of the cup carrier 20 is an elongated band 28 having a sector of annulus shape. The band 28 has a top edge 36 and a bottom edge 38. The edges 36 and 38 are parallel to each other and have an arcuate shape. The sleeve 22 when assembled by securing the first edge 30 under the second edge 32 forms a frusto-conical shape wherein the circumference of the top edge 36 and the diameter of the resulting opening is greater than that of the bottom edge 38. The overlapping edges are secured together by at least one fastener 34. In one arrangement the fastener is a rivet. In an alternative arrangement, the overlapping edges are secured with an adhesive. One of the overlapping edges is referred to as a securing tab 42 which is shown by hidden line in FIG. 1.

Still referring to FIG. 2, the sleeve 22 has four holes 44a-44d. Each of the holes 44 receives an attachment point of the strings 24 and 26 which in the arrangement shown is an end 46 of one of the strings 24 and 26. The ends of the strings 24 and 26 are knotted to secure the strings 24 and 26 to the sleeve. In an arrangement, the holes 44 have a reinforcing ring 48 to minimize stress concentrations on the sleeve 22.

The sleeve 22 in addition has a pair of fold lines 50a and 50b. In one arrangement, the sleeve 22 is made of synthesized paper; a plastic with a vellum-like surface. In another arrangement, the sleeve is made of vinyl. While in either arrangement the sleeve 22 can be folded flat for storage, it is recognized that the fold lines 50a and 50b are more pronounced on the synthesized paper. It is recognize that dependent on the material, the sleeve 22 can be rolled-up in lieu of folding for storage.

In one arrangement, the sleeve 22 has a height 52 of 2⅝ inches. The top edge 36 of the sleeve 22 defines a circumference of approximately 11 inches and an opening diameter of 3.5 inches. The diameter of opening at the bottom edge 32 is approximately 2¾ inches. If the sleeve 22 is divided into five segments, the attachment points 44 are located in the second fifth from the top edge 36. The holes 44, the fastening points for the strings 24 and 26, are spaced 2 ⅜ inches apart and are located ¾ inches below the top edge 36.

It is recognized that in an alternative arrangement, the sleeve 22 does not have holes 44 for securing the strings 24 and 26, but rather the strings 24 and 26 are secured to the sleeve 22 by another method such as using an adhesive or staple.

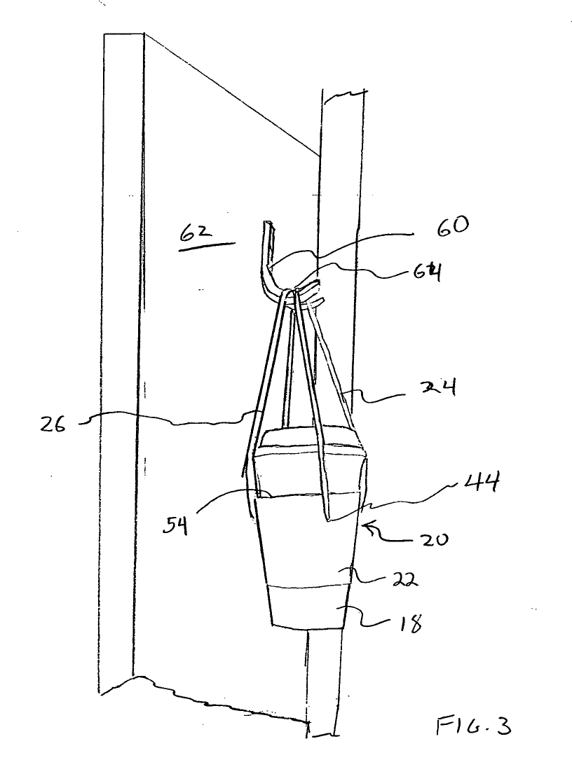

Referring to FIG. 3, the cup carrier 20 is shown hanging from a hook 60 on a vertical surface 62, such as a door. The cup carrier 20 allows a user to keep the cup 18 substantially upright even when there is no desirable flat surface on which to place the cup 18. Generally the strings 24 and 26 engage the hook at a middle point 64 of the string such that an equal length of string extends from the hook to all four fastening points, i.e., the holes 44.

In one arrangement, the strings 24 and 26 have a length of approximately 17½ inches from fastening point 44 to fastening point 44 on the sleeve. The location of the fastening points are equally spaced such that the fastening points are generally 90 degrees or π/2 radians apart from each other around the sleeve 22 and the opening that receives the cup 18.

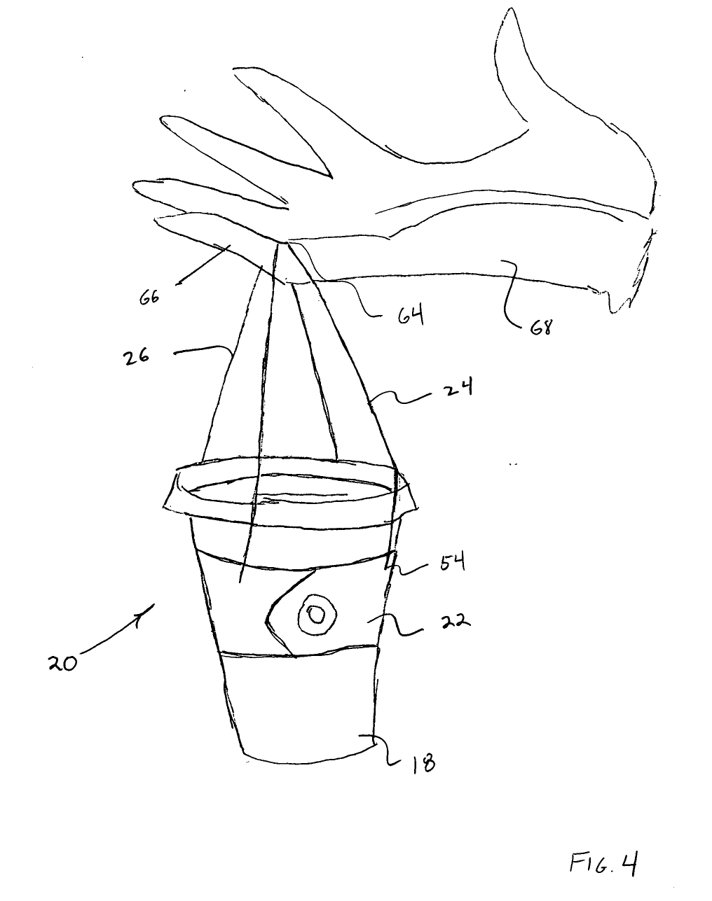

Referring to FIG. 4, the cup carrier 20 is shown being held by a finger 66 of a hand 68. The two strings 24 and 26 are shown looped over the small finger 66 of the user's hand 68. The user can hold other items in the hand 68.

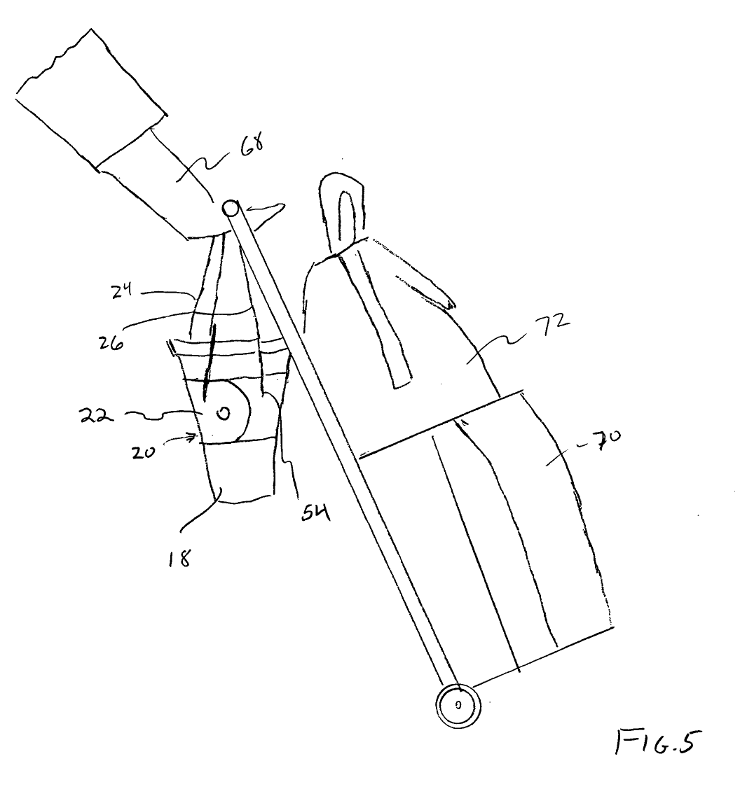

Referring to FIG. 5, a user is shown pulling a rolling suitcase 70 and another bag 72 and holding a cup carrier 20 with his/her hand 68. The cup 18 carried in the sleeve 22 extends down from the strings 24 and 26 of the cup carrier 20. The user can use one hand 68 to tote the cup 18 and at the same time roll the suitcase 70.

One possible use of the cup carrier 20 is the user has packed the cup carrier 20 in their carry-on bag 70 for a trip. The user arrives at the airport and purchases a drink in a cup 18. The user can place the cup 18 in the cup carrier 20. The user does not need to devote an entire hand 68 to holding the cup 18. The cup 18 retained by the cup carrier 20 is held level by grasping the strings 24 and 26 in the same hand 68 that is pulling the rolling suitcase 70 with an additional bag 72 in FIG. 5. The user's other hand, not shown, could be occupied with other items, such as a cell phone, and therefore is not capable of holding the cup 18.

The user as s/he continues on their trip to the gate, needs to use the rest room; the user can place the strings 24 and 26 of the cup carrier 20 over the hook 60 on the door 62 of the stall as seen in FIG. 4. The cup carrier 20 keeps the cup 18 in an upright position. The user does not need to locate a flat location that the user can observe on which to place the cup 18 in that the cup carrier 20 can be hung from the hook on the back of the door 62.

It is recognized that the hook 60 can be located in several locations including other rest room facilities or lavatories such as an outhouse, portable toilet, bathroom, stall, or latrine. In addition, the hook 60 could be located on other devices such as a hook molded on luggage. Likewise, items such as seat backs at stadiums could have a hook or have an attachment that fits over the seat back to receive the strings 24 and 26.

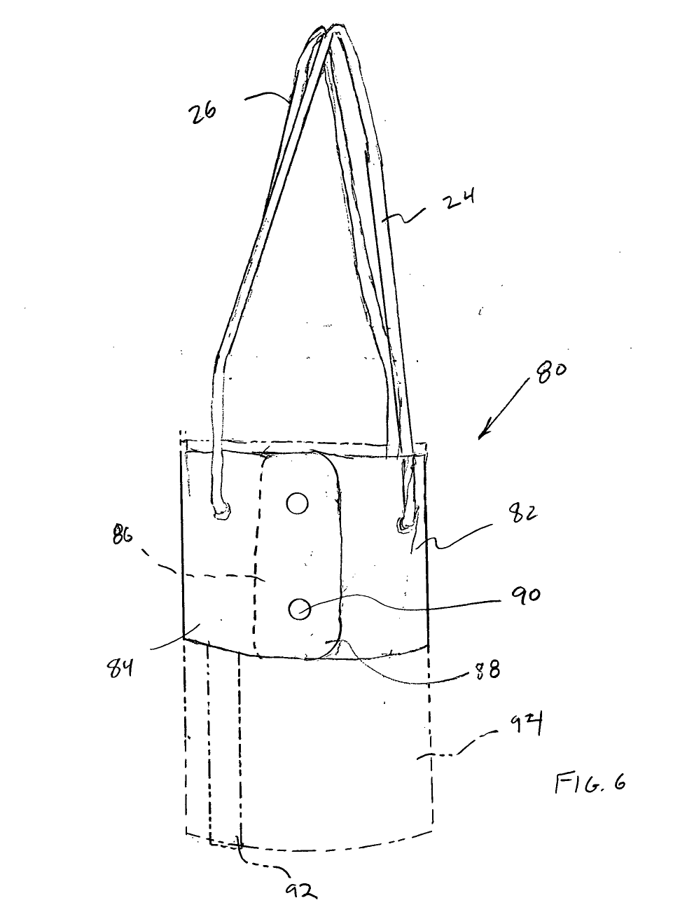

Referring to FIG. 6, an alternative cup carrier 80 is shown. The cup carrier 80 has a sleeve 82 that forms a cylindrical opening, in contrast to the frusto-concial shape of the arrangements of the previous FIGS. The cup carrier 80 holds a can 94 shown in phantom. The cup carrier 80 has the sleeve 82 and the pair of strings 24 and 26. The strings 24 and 26 are each attached to the sleeve 82 in proximity to the ends of the strings 24 and 26. The sleeve 82 is an elongated band 84 having a first edge 86, shown in hidden line, underlying a second edge 88. The edges 86 and 88 are secured together with a pair of fasteners 90.

Still referring to FIG. 6, in one arrangement a retaining band 92 projects from the elongated band 84 to hold the can 94. In one arrangement, the cup carrier 80 is sized such that the can 94 is held in by friction. In another arrangement, the cup carrier 80 is formed of a material that compresses radially to retain the can 94.

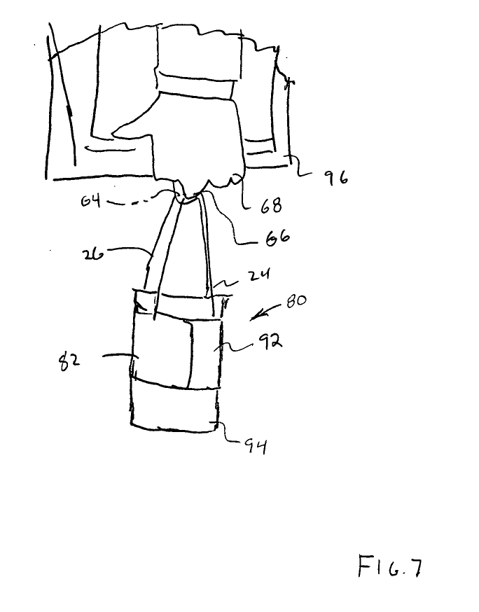

Referring to FIG. 7, the cup carrier 80 is held by a hand 68 is shown. The middle point 64 of the strings 24 and 26 loops over the finger 66 of the user's hand 68. The user in addition to holding the can 94 can hold a plurality of papers and notebooks 96 in the same hand 68.

It is recognized that the style of the cup carrier 20 and the cup 18/can 94, and the location of use are just examples. While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

It is recognized that string includes other elongated items such as twine, cable, or wire. It is recognized in some arrangement, a chain may be desired. It is recognized that the sleeve can be made of other materials such as corrugated paper material or reinforced embossed material.

What is claimed is:

1. A cup carrier for receiving a cup, the cup carrier comprising:
a sleeve defining an opening to receive the cup, the sleeve having a plurality of attachment points; and
a pair of strings, each of the strings attached at a pair of points to the sleeve at the attachment points forming a loop in each of the strings.

2. A cup carrier of claim 1 wherein the plurality of attachments points are four points equally spaced around the circumference of the sleeve.

3. A cup carrier of claim 1 wherein each of the strings has a length of greater than 10 inches between attachment points to the sleeve.

4. A cup carrier of claim 1 wherein the sleeve forms a frusto-conical opening for receiving the cup.

5. A cup carrier of claim 1 wherein the sleeve is an elongated band having a first edge and second edge, the first edge overlapping the second edge to form the sleeve.

6. A cup carrier of claim 5 wherein the first edge of the elongated band is secured to the second edge of the elongated band by at least one fastener.

7. A cup carrier of claim 5 wherein the first edge of the elongated band is secured to the second edge of the elongated band by an adhesive.

8. A cup carrier of claim 1 wherein the sleeve has a minimum of two fold lines allowing the sleeve to fold to generally a flat shape.

9. A cup carrier of claim 1 wherein the sleeve forms a cylindrical opening for receiving the cup.

10. A cup carrier of claim 10 further comprising a retaining band for facilitating retaining the cup.

11. A cup carrier of claim 1 wherein the cup is a can.

12. A method of holding a cup comprising:
providing a cup carrier including a sleeve having an upper edge and a lower edge, the sleeve forming an opening for receiving the cup, the sleeve having a plurality of attachment points and a pair of strings attached to sleeve;
placing the cup in the opening defined by the sleeve; and
retaining the strings to hold the cup.

13. A method of holding a cup of claim 12 wherein the strings are retained by a hook.

14. A method of holding a cup of claim 13 wherein the hook is located in a lavatory of the group consisting of an outhouse, portable toilet, bathroom, stall, and latrine.

15. A method of holding a cup of claim 13 wherein the hook is located on a piece of luggage.

16. A method of holding a cup of claim 12 wherein the strings are retained by a hand.

17. A cup carrier for receiving a cup, the cup carrier comprising:
an elongated band having a sector of annulus shape with an upper edge, a lower edge, a first edge and a second edge, the first edge underlying and secured to the second edge to form a sleeve defining a frusto-conical opening for receiving the cup;
the sleeve having four attachment point equally spaced around the circumference of the sleeve; and
a pair of strings, each of the strings attached at a pair of points to the sleeve at the attachment points forming a loop in each of the strings.

18. A cup carrier of claim 17 wherein each of the strings has a length of between 14 and 20 inches between attachment points to the sleeve.

19. A cup carrier of claim 17 wherein the elongated band having a height of between of 2½ and 2¾ inches and the four attachment points are located in the second-fifth from the upper edge of the elongated band.

20. A cup carrier of claim 17 wherein the elongated band is formed of a vinyl material.
